(19) United States
(12) Patent Application Publication
(10) Pub. No.: US 2013/0088284 A1
(43) Pub. Date: Apr. 11, 2013

(54) SEMICONDUCTOR DEVICE

(71) Applicant: Tae Seong JEONG, Seongnam-si (KR)

(72) Inventor: Tae Seong JEONG, Seongnam-si (KR)

(73) Assignee: SK HYNIX INC., Icheon-si (KR)

(21) Appl. No.: 13/614,721

(22) Filed: Sep. 13, 2012

(30) Foreign Application Priority Data
Oct. 5, 2011 (KR) 10-2011-0101390

(51) Int. Cl. G05F 1/10

(52) U.S. Cl. 327/537; 327/535

(57) ABSTRACT

A semiconductor device includes a precharge circuit configured to precharge a voltage output node, a boosting circuit configured to boost a voltage at the voltage output node by a predetermined level after the voltage output node is precharged, and a voltage supply circuit configured to supply a pumping voltage to increase the voltage at the voltage output node to a target level.

### CROSS-REFERENCE TO RELATED APPLICATION

The present application claims priority to Korean patent application number 10-2011-0101390 filed on Oct. 5, 2011, the entire disclosure of which is incorporated herein by reference in its entirety.

### BACKGROUND

1. Field of Invention

Embodiments relate generally to a semiconductor device and to a semiconductor device using a high voltage.

2. Related Art

An external voltage is supplied from an external power supply to a semiconductor device to operate the semiconductor device, which then generates internal power to be consumed inside the semiconductor device by using external power. Though external power is being reduced to minimize power consumption of a semiconductor device, an internal voltage higher than an external voltage may be required inside the semiconductor device.

For example, a high voltage of approximately 20V is required to perform a program operation of storing data in memory cells in a NAND flash memory device. Therefore, a semiconductor device needs a high voltage supply circuit configured to generate a high voltage. This high voltage supply circuit may be realized by using a pumping circuit that increases an external voltage. A high voltage is selectively supplied to memory cells through switching devices. At this time, since the high voltage applied to the memory cells is reduced by threshold voltages of the switching devices, the high voltage that does not reach the target level may be applied to the memory cells.

### BRIEF SUMMARY

Embodiments relate to a semiconductor device capable of stably supplying and transferring a high voltage.

A semiconductor device according to an embodiment of the present invention includes a precharge circuit configured to precharge a voltage output node; a boosting circuit configured to boost a voltage at the voltage output node by a predetermined level after the voltage output node is precharged; and a voltage supply circuit configured to supply a pumping voltage to increase the voltage at the voltage output node to a target level.

A semiconductor device according to another embodiment of the present invention includes a voltage setting circuit configured to increase an initial voltage at a voltage output node to a first level and a second level in a sequential manner; a voltage supply circuit configured to supply a pumping voltage to increase the voltage at the voltage output node to a target level when the initial voltage at the voltage output node becomes greater than an operation allowing level; and a switching device configured to transfer an operating voltage in response to the voltage at the voltage output node.

### BRIEF DESCRIPTION OF THE DRAWINGS

FIG. 1 is an example of a circuit diagram of a semiconductor device according to an embodiment;

FIG. 2 is an example of a waveform illustrating operations of the semiconductor device according to an embodiment of FIG. 1;

FIG. 3 is an example of a circuit diagram of a semiconductor device according to another embodiment;

FIG. 4 is an example of a waveform illustrating operations of the semiconductor device according to an embodiment of FIG. 3; and

FIG. 5 is an example of a circuit diagram of a NAND flash memory device to which a semiconductor device according to another embodiment is applied.

### DETAILED DESCRIPTION

Hereinafter, various embodiments of the present disclosure will be described in detail with reference to the accompanying drawings. The figures are provided to allow those having ordinary skill in the art to understand the scope of the embodiments of the disclosure. The present embodiments may, however, be embodied in different forms and should not be construed as limited to the embodiments set forth herein. Rather, these embodiments are provided so that this disclosure will be thorough and complete, and will fully convey the scope of the present invention to those skilled in the art.

The drawings are not necessarily to scale and in some instances, proportions may have been exaggerated in order to clearly illustrate features of the embodiments. In this specification, specific terms have been used. The terms are used to describe the present invention, and are not used to qualify the sense or limit the scope of the present invention.

In this specification, ‘and/or’ represents that one or more of components arranged before and after ‘and/or’ is included. Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

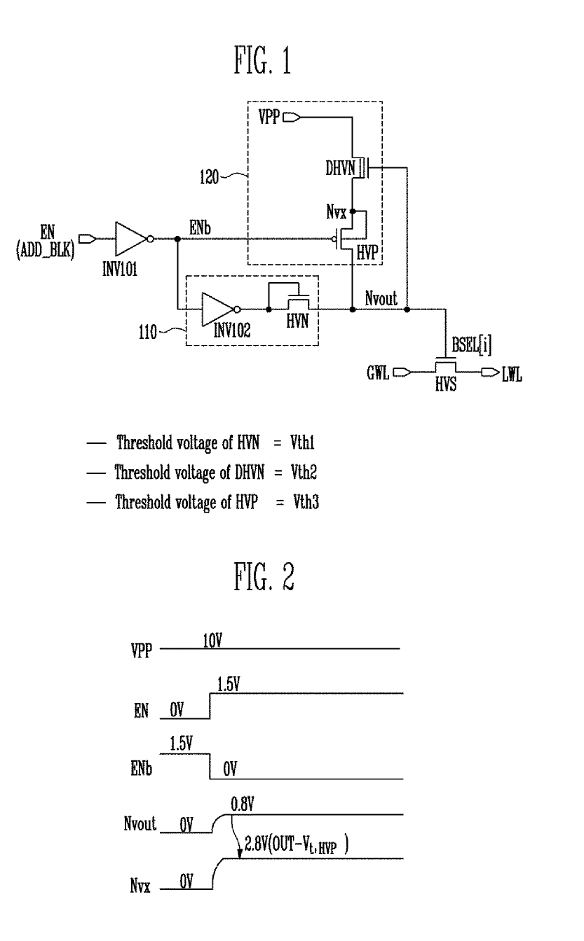

FIG. 1 is an example of a circuit diagram of a semiconductor device according to an embodiment.

Referring to FIG. 1, the semiconductor device may include a precharge circuit 110 and a voltage supply circuit 120. The semiconductor device may further include an inverter INV101 and a switching device HVS. The inverter INV101 may be configured to output an inverted enable signal Enb by using an enable signal EN. The switching device HVS may be configured to transfer operating voltages in response to voltage supplied from the voltage supply circuit 120.

The precharge circuit 110 may be configured to precharge a voltage output node Nvout. Specifically, the precharge circuit 110 may include an inverter INV102 and a diode HVN so that the precharge circuit 110 may precharge the voltage output node Nvout in response to the inverted enable signal Enb. The inverter INV102 may be configured to invert the inverted enable signal Enb, and the diode HVN may be configured to precharge the voltage output node Nvout in response to an output voltage from the inverter INV102. The diode HVN may be formed of an NMOS transistor that has a gate coupled to a drain to which the output voltage from the inverter INV102 may be applied, and a source coupled to the voltage output node Nvout. Preferably, the diode HVN may be formed of a high voltage NMOS transistor.

The precharge circuit 110 may be configured to precharge the voltage output node Nvout to a level corresponding to a voltage obtained by reducing a power voltage, output from the inverter INV102, by a threshold voltage of the diode HVN when the enable signal EN is activated. Therefore, the level to which the voltage output node Nvout may be precharged by the precharge circuit 110 may vary depending on a level of the power voltage, and preferably may be proportional to the level of power voltage.

The voltage supply circuit 120 may be configured to supply a pumping voltage VPP to the voltage output node Nvout to increase a voltage at the voltage output node Nvout to a target level. To this end, the voltage supply circuit 120 may include two transistors (DHVN and HVP). A first transistor DHVN may be coupled between a first node Nvx and a terminal to which the pumping voltage VPP may be input, and has a gate coupled to the voltage output node Nvout. Preferably, the first transistor DHVN may be formed of a depletion NMOS transistor. A second transistor HVP may be coupled between the first node Nvx and the voltage output node Nvout and has a gate to which the enable signal EN may be applied. Preferably, the second transistor HVP may be formed of a high voltage PMOS transistor.

The voltage supply circuit 120 may be configured to supply the pumping voltage VPP to the voltage output node Nvout in order to increase the voltage at the voltage output node Nvout to the target level when an initial voltage at the voltage output node Nvout precharged by the precharge circuit 110 becomes greater than an operation allowing level.

The voltage at the voltage output node Nvout may be used as a driving signal BSEL[i] of the switching device HVS.

The above-described semiconductor device (INV101, 110 and 120) may become part of a row decoder that may be used in a NAND flash memory device. In this case, the switching device HVS may become part of a switching circuit that couples global lines GWL (or global word lines) and local lines LWL (or local word lines) to transfer operating voltages to memory cells included in memory blocks or select transistors. At this time, the enable signal EN may be a row address signal decoded to select one of a plurality of memory blocks, and the voltage at the voltage output node Nvout may be used as a block selection signal BSEL[i].

Operations of the above-described semiconductor device are described below.

It may be assumed, for example, that the diode HVN has a threshold voltage Vth1 of 0.7V, the first transistor DHVN may have a threshold voltage Vth2 of −2V, the second transistor HVP may have a threshold voltage Vth3 of −3V, and the pumping voltage VPP may be about 10V.

When the enable signal EN is activated, the voltage at the voltage output node Nvout precharged by the precharge circuit 110 may satisfy Vcc-Vth1. Meanwhile, a voltage at the first node Nvx may increase to VPP-Vth2. When the voltage at the first node Nvx increases to a voltage level high enough to turn on the second transistor HVP, both the first and second transistors DHVN and HVP may be turned on, increasing the voltage at the voltage output node Nvout to the pumping voltage VPP.

At this time, Vsg (source to gate voltage)+Vth3 is to be greater than 0V in order to turn on the second transistor HVP. When this condition is satisfied, the voltage at the voltage output node Nvout may become greater than the pumping voltage VPP, which may then be applied to the switching device HVS. As a result, the switching device HVS may transfer a high voltage without causing a voltage drop.

During an operation of turning off the switching device HVS, the enable signal EN may be deactivated to a low voltage level, and the inverted enable signal Enb may become a high voltage level. In addition, the pumping voltage VPP may be reduced, thereby blocking a path between the terminal to which the pumping voltage VPP is applied and the voltage output node Nvout. Meanwhile, an NMOS transistor that may operate in response to the inverted enable signal Enb may be provided between the voltage output node Nvout and a ground terminal to discharge the voltage output node Nvout. As a result, the voltage output node Nvout may be completely lowered to a ground voltage level, and the switching device HVS may be turned off.

A detailed example based on the above-described voltage setting conditions is given below.

First, a description will be made in reference to an example when a level of the enable signal EN becomes 2V corresponding to a power voltage level, and a level of the inverted enable signal Enb becomes 0V.

In this example, the voltage output node Nvout may be precharged to 1.3V corresponding to Vcc-Vth1 (threshold voltage of diode HVN). In addition, the voltage at the first node Nvx may become 3.3V corresponding to the voltage at the voltage output node Nvout-Vth2 (threshold voltage of first transistor DHVN) from the voltage at the voltage output node Nvout. At this time, since Vsg+Vth3 (threshold voltage of second transistor HVP) may become 0.3V higher than 0V, the second transistor HVP may be turned on. Therefore, a positive feedback operation may be performed such that the voltage at the voltage output node Nvout may be increased by the voltage at the first node Nvx, and the increased voltage at the voltage output node Nvout may increase the voltage at the first node Nvx, thereby increasing the voltage at the voltage output node Nvout to the pumping voltage VPP.

Through these operations, a high enough voltage may be applied to the voltage output node Nvout, and the switching device HVS may stably transfer the operating voltages having a high voltage level without causing a voltage drop.

However, when a power voltage having a lower voltage level is supplied to the semiconductor device according to the embodiment in order to reduce power consumption, a high voltage may not be applied to the voltage output node Nvout. This will be described below.

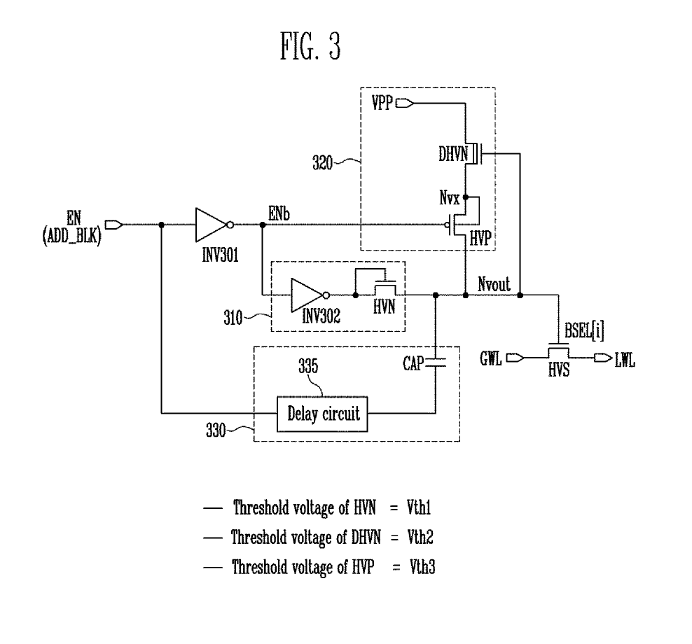

FIG. 2 is an example of a waveform illustrating operations of the semiconductor device according to an embodiment illustrated in FIG. 1. A description will be made to an example that the same threshold voltages of the diode HVN and the transistors (DHVN and HVP) as described above are used, and the power voltage Vcc decreases from 2V to 1.5V.

Referring to FIGS. 1 and 2, the voltage output node Nvout may be precharged to 0.8V corresponding to Vcc-Vth1 (threshold voltage of diode HVN). In addition, the voltage at the first node Nvx may become 2.8V corresponding to the voltage at the voltage output node Nvout-Vth2 (threshold voltage of first transistor DHVN) from the voltage at the voltage output node Nvout. Here, since Vsg+Vth3 (threshold voltage of second transistor HVP) may become −0.2V lower than 0V, the second transistor HVP may be turned off. The pumping voltage VPP may not be applied to the voltage output node Nvout, and a positive feedback loop may not be formed. For these reasons, the voltage at the voltage output node Nvout may be maintained at 0.8V corresponding to the level to which the voltage output node Nvout may be precharged by the precharge circuit 110. As a result, the switching device HVS may not operate properly.

Hereinafter, a semiconductor device according to another embodiment may properly operate even when a level of a power voltage is lowered will be described below.

FIG. 3 is a circuit diagram of a semiconductor device according to another embodiment.

Referring to FIG. 3, the semiconductor device may include a precharge circuit 310, a boosting circuit 330, and a voltage supply circuit 320. The semiconductor device may further include an inverter INV301 and a switching device HVS. The inverter INV301 may be configured to output the inverted enable signal Enb (i.e., EN_N) [please see FIG. 4] by using the enable signal EN. The switching device HVS may be configured to transfer operating voltages in response to voltage supplied from the voltage supply circuit 320.

Here, the precharge circuit 310 and the boosting circuit 330 may be used as a voltage setting circuit configured to precharge the voltage output node Nvout to a first level and boost the voltage output node Nvout to a second level. In addition, the voltage supply circuit 320 may be configured to apply the pumping voltage VPP to the voltage output node Nvout in order to increase the voltage at the voltage output node Nvout to the target level when an initial voltage at the voltage output node Nvout becomes greater than an operation allowing level.

The precharge circuit 310 and the voltage supply circuit 320 may be substantially the same as the precharge circuit 110 and the voltage supply circuit 320 as described in connection with FIG. 1, respectively. Thus, a detailed description of the precharge circuit 310 and the voltage supply circuit 320 will be omitted.

After a predetermined amount of time from when the precharge circuit 310 precharges the voltage output node Nvout to the first level, the boosting circuit 330 may perform a boosting operation to increase the voltage at the voltage output node Nvout from the first level to the second level.

The boosting circuit 330 may include a delay circuit 335 and a capacitor CAP. The delay circuit 335 may be configured to delay the enable signal EN for a predetermined amount of time. Specifically, when the enable signal EN is activated at a high voltage level, the delay circuit 335 may output the enable signal EN activated at the high voltage level to the capacitor CAP after the predetermined amount of time. The capacitor CAP may be coupled between an output terminal of the delay circuit 335 and the voltage output node Nvout. In addition, the capacitor CAP may be configured to boost the voltage at the voltage output node Nvout in response to the enable signal EN delayed (i.e., EN_DEL) [please see FIG. 4] by the delay circuit 335.

The boosting circuit 330 may boost the voltage at the voltage output node Nvout by an active level of the enable signal EN that increases from low voltage level to high voltage level when the enable signal EN is activated. At this time, the active level of the enable signal EN increasing from low voltage level to a high voltage level corresponds to the level of the power voltage. Therefore, the boosting circuit 330 may boost the voltage at the voltage output node Nvout by the power voltage.

Since a positive feedback loop may be formed by the transistors (DHVN and HVP) included in the voltage supply circuit 320 when the voltage at voltage output node Nvout becomes sufficiently high, the voltage supply circuit 320 may increase the voltage at the voltage output node Nvout to the target level when the voltage at the voltage output node Nvout becomes greater than the operation allowing level.

That is, when the voltage output node Nvout is precharged to a voltage level higher than the operation allowing level of the voltage supply circuit 320 by the precharge circuit 310, a positive feedback loop may be formed by the transistors (DHVN and HVP), and the voltage supply circuit 320 may start an operation of increasing the voltage at the voltage output node Nvout to the target voltage level before the voltage at the voltage output node Nvout is boosted to the second level by the boosting circuit 330.

On the other hand, when the voltage at the voltage output node Nvout is precharged to a voltage level lower than the operation allowing level of the voltage supply circuit 320 by the precharge circuit 310, a positive feedback loop may be formed, and the voltage supply circuit 320 may start an operation of increasing the voltage at the voltage output node Nvout to the target voltage level after the voltage at the voltage output node Nvout is boosted to the second level higher than the operation allowing level by the boosting circuit 330 transistors (DHVN and HVP).

Operations of the semiconductor device as illustrated in FIG. 3 are described below. Here, the conditions described in connection with FIG. 2 are applied to threshold voltages of the diode HVN and the transistors (DHVN and HVP) and the power voltage Vcc of FIG. 3.

FIG. 4 is a waveform illustrating operations of the semiconductor device according to the embodiment of the present invention as shown in FIG. 3.

Referring to FIGS. 3 and 4, the voltage output node Nvout (i.e., GATE) [please see FIG. 4] may be precharged to 0.8V corresponding to Vcc-Vth1 (threshold voltage of diode HVN). The voltage at the first node Nvx (i.e., Vx) [please see FIG. 4] may become 2.8V corresponding to the voltage at the voltage output node Nvout-Vth2 (threshold voltage of first transistor DHVN). At this time, since Vsg+Vth3 (threshold voltage of second transistor HVP) may become −0.2V lower than 0V, the second transistor HVP may be turned off. Therefore, a positive feedback loop may not be formed, and the pumping voltage VPP may not be supplied to the voltage output node Nvout, so that the voltage at the voltage output node Nvout may be maintained at 0.8V corresponding to the level to which the voltage output node Nvout may be precharged by the precharge circuit 310.

After a predetermined amount of time from when the enable signal EN may be activated, the boosting circuit 330 may boost the voltage at the voltage output node Nvout. At this point, when a coupling ratio of the capacitor CAP is 0.5, the voltage at the voltage output node Nvout may be increased by 0.5×Vcc by the boosting operation of the boosting circuit 330. That is, the voltage at the voltage output node Nvout may increase from 0.8V to 1.55V. Ideally, the coupling ratio should be 1, and the voltage at the voltage output node Nvout may increase by the power voltage.

In addition, the voltage at the first node Nvx becomes 3.55V corresponding to the voltage at the voltage output node Nvout-Vth2 (threshold voltage of first transistor DHVN). At this time, since Vsg+Vth3 (threshold voltage of second transistor HVP) becomes 0.55V higher than 0V, the second transistor HVP may be turned on. Therefore, a positive feedback operation may be performed such that the voltage at the voltage output node Nvout may increase by the voltage at the first node Nvx, and the voltage at the voltage output node Nvout may increase the voltage at the first node Nvx, thereby increasing the voltage at the voltage output node Nvout to the target level.

However, when the power voltage Vcc of a high level is applied, before the boosting circuit 330 boosts the voltage at the voltage output node Nvout, a positive feedback loop may be formed by the transistors (DHVN and HVP), and the voltage supply circuit 320 may start an operation of increasing the voltage at the voltage output node Nvout to the target level.

Through these operations, a sufficiently high voltage may be applied to the voltage output node Nvout even when the power voltage Vcc may be reduced, and the switching device HVS may transfer operating voltages having a high level without causing a voltage drop.

That is, even when the level of the power voltage changes, a sufficiently high voltage may be stably applied to the voltage output node Nvout without changing circuit designs or manufacturing processes, and the switching device HVS may properly transfer the operating voltages.

The above-described semiconductor device can increase area, reduce power consumption and transfer a high voltage by using a minimum number of semiconductor elements, with no addition of a large-sized pumping circuit even a power voltage is applied at a low voltage level. Since a level shifter or a high voltage transistor is additionally required when another pump circuit provided inside a semiconductor chip is used, there is little difference in terms of increase in area in comparison with the case that the boosting circuit is added. Rather, circuit designs can be simplified, and power consumption can be reduced.

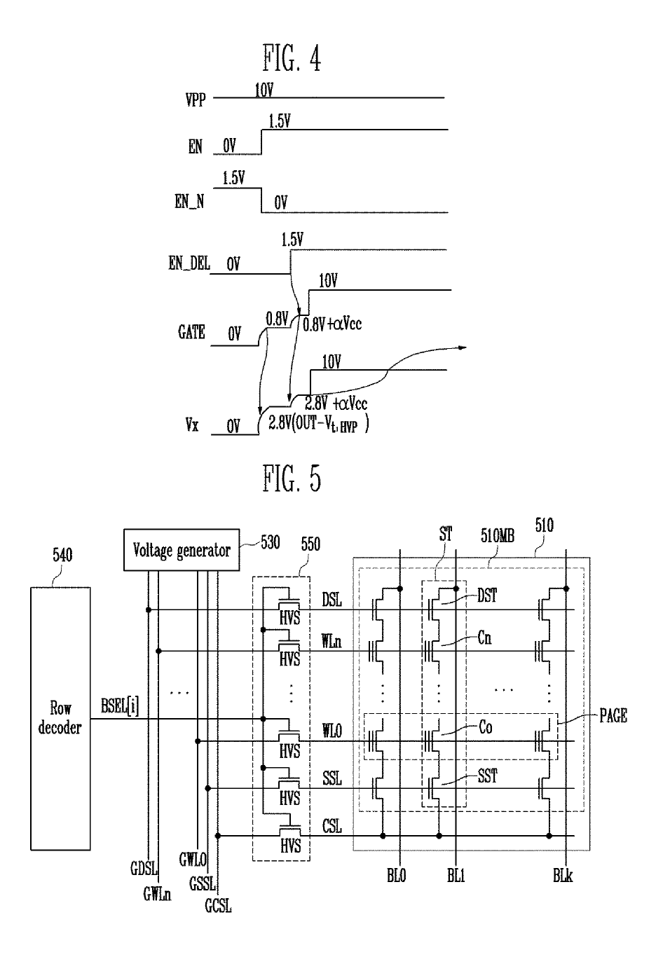

FIG. 5 is an example of a circuit diagram of a NAND flash memory device to which a semiconductor device according to another embodiment may be applied.

Referring to FIG. 5, the flash memory device may include a memory array 510 including a plurality of memory blocks 510MB and voltage supply circuits (530 to 550). In FIG. 5, one of the memory blocks 510MB is shown for illustration purposes. The voltage supply circuits may include a voltage generator 530, a row decoder 540, and a switching circuit 550.

The memory block 510MB may include memory strings ST coupled between bit lines BL0 to BLk and a common source line CSL. Gates of memory cells C0 to Cn of the memory strings ST may be coupled to word lines WL0 to WLn, respectively. Gates of a drain select transistor DST that couple the memory strings ST to the bit lines BL0 to BLk, respectively, may be coupled to a drain select line DSL. Gates of source select transistors SST may couple the memory strings ST to the common source line CSL coupled to a source select line SSL. Memory cells coupled to the same word line (e.g., WL0) may be divided into page units (i.e., PAGE).

The voltage generator 530 may be configured to output voltages required to operate the memory cells to global lines (GDSL, GWL0 to GWLn, GSSL, and GCSL).

The row decoder 540 may be configured to output the block selection signal BSEL[i] for selecting one of the plurality of memory blocks 510 MB in response to an address signal.

The switching circuit 550 may include switching devices HVS coupled between the global lines (GDSL, GWL0 to GWLn, GSSL, and GCSL) and local lines (DSL, WL0 to WLn, SSL, and CSL) of the memory block 510MB. In addition, the switching devices HVS may be configured to operate depending on the block selection signal BSEL[i]. Specifically, when the block selection signal BSEL[i] is activated, the switching devices HVS may couple the global lines (GDSL, GWL0 to GWLn, GSSL, and GCSL) to the local lines (DSL, WL0 to WLn, SSL, and CSL) of the memory block 510MB to transfer the operating voltages output from the voltage generator 530 to the memory block 510MB.

The inverter INV101, the precharge circuit 110 and the voltage supply circuit 120 as described above with reference to FIG. 1 may be part of the row decoder 540. The switching device HVS as illustrated in FIG. 1 may be the switching device HVS of the switching circuit 550. In addition, the inverter INV301, the voltage setting circuit (310 and 330) and the voltage supply circuit 320 as described above with reference to FIG. 3 may be part of the row decoder 540. The switching device HVS as illustrated in FIG. 3 may be the switching device HVS of the switching circuit 550.

That is, when a semiconductor device according to an embodiment is applied to a flash memory device, operating voltages can be stably transferred to memory blocks even when a level of the power voltage changes.

According to various embodiments, a high voltage can be stably supplied and transferred.

While certain embodiments have been described above, it will be understood to those skilled in the art that the embodiments described are by way of example only. Accordingly, the device and methods described herein should not be limited based on the described embodiments. Rather, the embodiments have been disclosed above for illustrative purposes. Those skilled in the art will appreciate that various modifications, additions and substitutions are possible, without departing from the scope and spirit of the inventive concept as disclosed in the accompanying claims.

What is claimed is:

1. A semiconductor device, comprising:
a precharge circuit configured to precharge a voltage output node;
a boosting circuit configured to boost a voltage at the voltage output node by a predetermined level after the voltage output node is precharged; and
a voltage supply circuit configured to supply a pumping voltage to increase the voltage at the voltage output node to a target level.

2. The semiconductor device of claim 1, wherein the precharge circuit is configured to precharge the voltage output node in proportion to a power voltage.

3. The semiconductor device of claim 1, wherein the voltage supply circuit is configured to increase the voltage at the voltage output node to the target level when the voltage at the voltage output node becomes greater than an operation allowing level.

4. The semiconductor device of claim 1, wherein when the voltage output node is precharged to a level higher than an operation allowing level by the precharge circuit, the voltage supply circuit is configured to start an operation of increasing the voltage at the voltage output node to the target level before the voltage at the voltage output node is boosted by the boosting circuit.

5. The semiconductor device of claim 1, wherein when the voltage output node is precharged to a level lower than an operation allowing level by the precharge circuit, the voltage supply circuit is configured to start an operation of increasing the voltage at the voltage output node to the target level after the voltage at the voltage output node is boosted to a level higher than the operation allowing level by the boosting circuit.

6. The semiconductor device of claim 1, wherein the precharge circuit, the boosting circuit, and the voltage supply circuit are configured to operate in response to an enable signal.

7. The semiconductor device of claim 6, wherein the boosting circuit is configured to boost the voltage at the voltage output node after a predetermined amount of time from when the enable signal is activated.

8. The semiconductor device of claim 6, wherein the boosting circuit is configured to boost the voltage at the voltage output node by a level at which the enable signal is activated.

9. The semiconductor device of claim 6, wherein the boosting circuit is configured to boost the voltage at the voltage output node by a power voltage.

10. The semiconductor device of claim 1, further comprising a switching device configured to transfer an operating voltage in response to the voltage at the voltage output node.

11. The semiconductor device of claim 1, wherein the precharge circuit comprises:
a first inverter to which an inverted enable signal is input; and
a diode configured to precharge the voltage output node in response to an output voltage from the first inverter.

12. The semiconductor device of claim 1, wherein the boosting circuit comprises:
a delay circuit configured to delay an enable signal; and
a capacitor coupled between an output terminal of the delay circuit and the voltage output node and configured to boost the voltage at the voltage output node in response to the enable signal delayed by the delay circuit.

13. The semiconductor device of claim 1, wherein the voltage supply circuit comprises:
a first transistor coupled between a first node and a terminal to which the pumping voltage is input and having a gate coupled to the voltage output node; and
a second transistor coupled between the first node and the voltage output node and having a gate to which an enable signal is applied.

14. A semiconductor device, comprising:
a voltage setting circuit configured to increase an initial voltage at a voltage output node to a first level and a second level in a sequential manner;
a voltage supply circuit configured to supply a pumping voltage to increase the voltage at the voltage output node to a target level when the initial voltage at the voltage output node becomes greater than an operation allowing level; and
a switching device configured to transfer an operating voltage in response to the voltage at the voltage output node.

15. The semiconductor device of claim 14, wherein the voltage setting circuit further comprises:
a precharge circuit configured to precharge the voltage output node to the first level; and
a boosting circuit configured to boost the voltage at the voltage output node to the second level higher than the first level.

16. The semiconductor device of claim 15, wherein the precharge circuit comprises:
a first inverter to which an inverted enable signal is input; and
a diode configured to precharge the voltage output node in response to an output voltage from the first inverter.

17. The semiconductor device of claim 16, wherein the precharge circuit is formed of an NMOS transistor having a gate coupled to a drain to which the output voltage from the first inverter is applied and a source coupled to the voltage output node.

18. The semiconductor device of claim 15, wherein the boosting circuit comprises:
a delay circuit configured to delay an enable signal; and
a capacitor coupled between an output terminal of the delay circuit and the voltage output node and configured to boost the voltage at the voltage output node in response to the enable signal delayed by the delay circuit.

19. The semiconductor device of claim 14, wherein the voltage supply circuit comprises:
a first transistor coupled between a first node and a terminal to which the pumping voltage is input and having a gate coupled to the voltage output node; and
a second transistor coupled between the first node and the voltage output node and having a gate to which an enable signal is applied.

20. The semiconductor device of claim 19, wherein the first transistor is a depletion NMOS transistor.

21. The semiconductor device of claim 19, wherein the second transistor is a PMOS transistor.

22. The semiconductor device of claim 16, further comprising a second inverter configured to receive an enable signal and output the inverted enable signal.
